(19) United States
(12) Patent Application Publication
(10) Pub. No.: US 2008/0176434 A1
(43) Pub. Date: Jul. 24, 2008

(54) Electrical connector

(75) Inventor: Chien-Chih Ho, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: LOTES CO., LTD.

(21) Appl. No.: 11/657,128

(22) Filed: Jan. 24, 2007

(51) Int. Cl. H01R 13/62

(52) U.S. Cl. 439/259

(57) ABSTRACT

An electrical connector for connection between a CPU and a circuit board is disclosed to include an electrically insulative housing, which houses a plurality of conducting terminals and has a plurality of guide members symmetrically disposed at two opposite lateral sides and retaining members respectively vertically connected to the guide members for quick installation of a cap.

### BACKGROUND OF THE INVENTION

1. Field of the Invention

The present invention relates to electrical connectors and more particularly, to such an electrical connector, which has guide members and retaining members arranged at two opposite lateral sides for quick installation of a cap.

2. Description of the Related Art

An electrical connector for connection between two electronic devices, for example, between a CPU and a circuit board, is known comprised of a body shell, a cover shell for covering the body shell, and a plurality of conducting terminals mounted inside the body shell. The cover shell has a plurality of through holes for the insertion of conducting members of an external electronic device. The body shell has a plurality of terminal holes, which receive the conducting terminals respectively. For automatic installation, an electrical connector must provide a smooth surface that can be sucked up through a vacuum. This can be achieved by attaching a cap having a smooth surface to the electrically insulative housing. The cap has hooks extending from two opposite lateral sides. The cover shell of the electrically insulative housing has retaining grooves for receiving the hooks of the cap. During installation, the hooks of the cap must be aimed at the retaining grooves of the cover shell of the electrically insulative housing, and then a downward pressure is applied to the cap to force the hooks of the cap into engagement with the retaining grooves of the cover shell. However, the cap may slip relative to the cover shell of the electrically insulative housing when it is forced downwards by an external force. When this occurs, a re-alignment is necessary to have the cap be installed in the cover shell of the electrically insulative housing. In this case, much installation time is wasted.

Therefore, it is desirable to provide an electrical connector that eliminates the aforesaid problem.

### SUMMARY OF THE INVENTION

The present invention has been accomplished under the circumstances in view. It is the main object of the present invention to provide an electrical connector, which has guide members and retaining members arranged at each of the two opposite sides thereof for quick installation of a cap.

To achieve this and other objects of the present invention, the electrical connector comprises an electrically insulative housing, which has at least one guide member at each of two opposite lateral sides thereof and at least one retaining member respectively vertically connected to the at least one guide member at each of the two opposite lateral sides, and a plurality of conducting terminals respectively mounted inside the electrically insulative housing.

By means of the guide members, the matching cap can positively and accurately guided into engagement with the retaining members during its installation in the electrically insulative housing.

### BRIEF DESCRIPTION OF THE DRAWINGS

FIG. 1 is top view of an electrical connector according to the present invention.

FIG. 2 is a right side view of an electrical connector according to the present invention.

FIG. 3 is a sectional view taken along line A-A of FIG. 1.

FIG. 4 is a schematic drawing showing the cap fastened to the electrically insulative housing of the electrical connector according to the present invention.

FIG. 5 is a right side view of FIG. 4.

FIG. 6 is a sectional view taken along line B-B of FIG. 4.

FIG. 7 is a schematic drawing showing an alternate form of the electrical connector according to the present invention.

FIG. 8 is a schematic drawing showing another alternate form of the electrical connector according to the present invention.

### DETAILED DESCRIPTION OF THE INVENTION

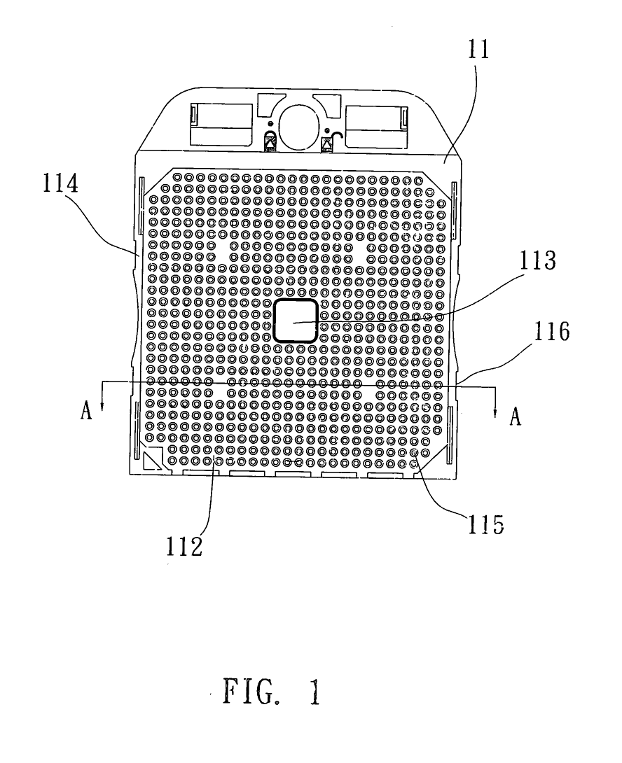

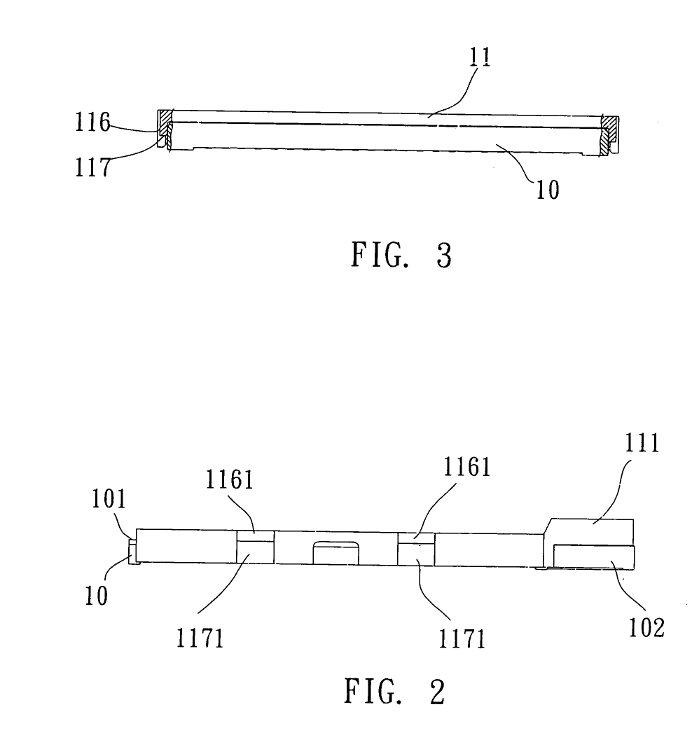

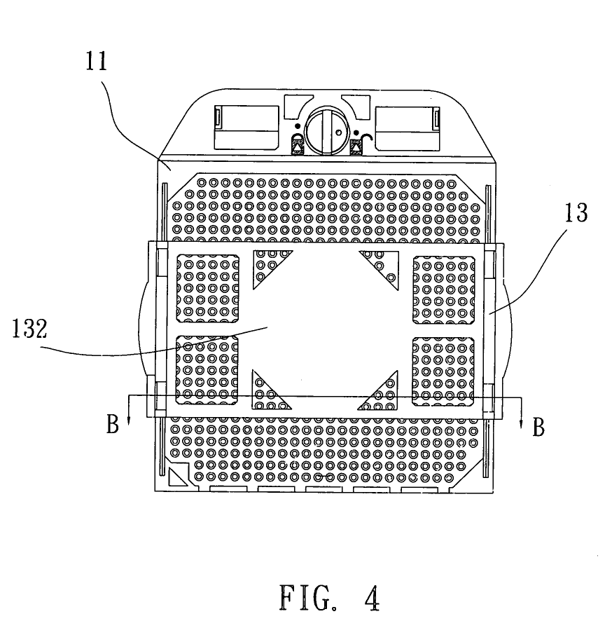

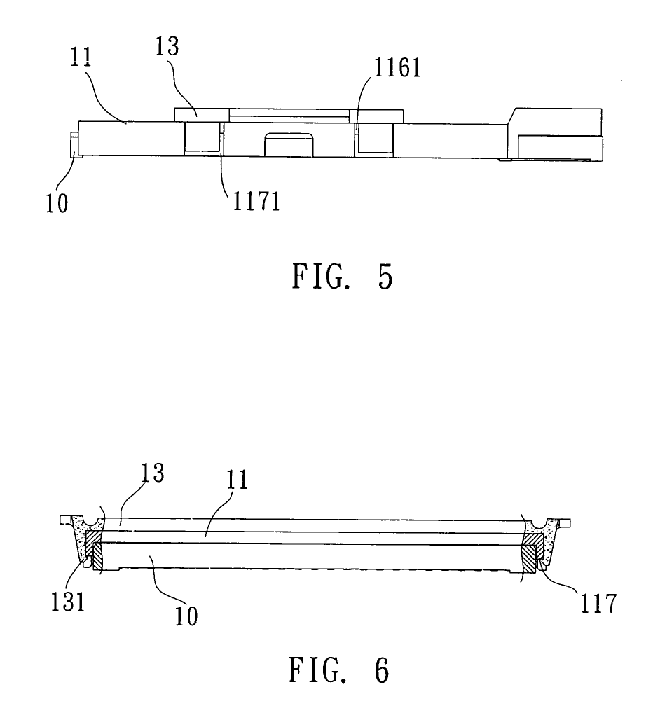

Referring to FIGS. 1˜8, an electrical connector in accordance with the present invention is adapted for connection between a CPU (Central Processing Unit) and a circuit board, comprising an electrically insulative housing and a plurality of conducting terminals (not shown) mounted inside the electrically insulative housing. The electrically insulative housing comprises a body shell 10 and a cover shell 11 fastened to the body shell 10. A driving device (not shown) is provided between the body shell 10 and the cover shell 11. Under the effect of the driving device, the cover shell 11 is movable relative to the body shell 10 to control connection/disconnection between the pins of the CPU and the conducting terminals.

The body shell 10 has a junction 101 facing the cover shell 11. The junction 101 has a plurality of terminal holes (not shown) extending through the bottom side for accommodating the conducting terminals (not shown). Further, a head 102 extends from the junction 101.

The cover shell 11 has a protruding mount 111 for the mounting of the aforesaid driving device, and a bearing surface 112 for receiving a CPU. The bearing surface 112 is a continuity plane having a center protrusion 113 and a frame 114 extending around the border at an equal height relative to the center protrusion 113.

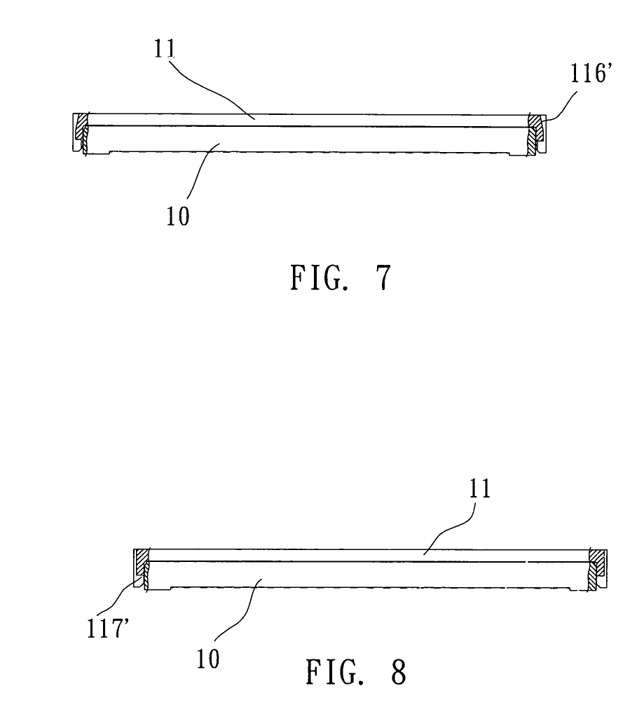

The bottom surface of the cover shell 11 opposite to the bearing surface 112 fits the junction 105 of the body shell 10. The cover shell 11 has a plurality of through holes 115 corresponding to the conducting terminals (not shown). The cover shell 11 further has two guide members 116 and two retaining members 117 respectively vertically connected at each of the two opposite lateral sides thereof. Each guide member 116 has a recessed portion 1161 (alternatively, each guide member can be made having a downwardly tilted wedge shape 116′ as shown in FIG. 7). Each retaining member 117 has a recessed portion 1171 (alternatively, each retaining member can be made in the form of a hole 117′ extending in direction perpendicular to one side of the cover shell 10). The recessed portion 1171 of each retaining member 117 is deeper than the recessed portion 1161 of each guide member 116. The recessed portion 1161 of each guide member 116 and the recessed portion 1171 of the associating retaining member 117 constitute a guide passage. Further, the guide members 116 and the retaining member 117 have a same width.

Further, a cam wheel for driving is provided between the body shell 10 and the cover shell 11. The cam wheel has mounted thereon a pin 12.

The electrical connector further comprises a cap 13. The cap 13 has two hooks 131 at each of the two opposite lateral sides for hooking up with the retaining members 117 of the cover shell 11. As stated above, the cover shell 11 has the aforesaid guide members 116. During installation of the cap 13, the hooks 131 of the cap 13 are placed on the guide members 116, and then impart a downward pressure to the cap 13 to move the hooks 131 downwards along the guide members 116 into engagement with the retaining members 117 respectively. The top surface 132 of the cap 13 is a smooth surface that can be sucked up through a vacuum during an automatic installation process.

Further, if the electrical connector is formed by connecting two electrically insulative housings together, the guide members and the retaining members can be provided at one electrically insulative housing, and the two electrically insulative housings can be fastened together in the same manner as the connection between the cap and the cover shell.

A prototype of electrical connector has been constructed with the features of FIGS. 1˜8. The electrical connector functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electrical connector comprising:
an electrically insulative housing, said electrically insulative housing having at least one guide member at each of two opposite lateral sides thereof and at least one retaining member respectively vertically connected to the at least one guide member at each of said two opposite lateral sides; and
a plurality of conducting terminals respectively mounted inside said electrically insulative housing.

2. The electrical connector as claimed in claim 1, wherein the at least one guide member at each of the two opposite lateral sides of said electrically insulative housing each has a downwardly tilted wedge shape.

3. The electrical connector as claimed in claim 1, wherein the at least one guide member at each of the two opposite lateral sides of said electrically insulative housing each has a recessed portion.

4. The electrical connector as claimed in claim 3, wherein the at least one retaining member at each of the two opposite lateral sides of said electrically insulative housing each has a recessed portion relatively deeper than the recessed portion of the associating guide member.

5. The electrical connector as claimed in claim 4, wherein the recessed portion of each of the at least one guide member at each of the two opposite sides of said electrically insulative housing is connected to the recessed portion of the associating retaining member, constituting a guide passage.

6. The electrical connector as claimed in claim 1, wherein the at least one retaining member at each of the two opposite lateral sides of said electrically insulative housing each is a groove extending in direction perpendicular to the respective lateral side of said electrically insulative housing.

7. The electrical connector as claimed in claim 1, wherein each of the at least one retaining member at each of the two opposite lateral sides of said electrically insulative housing and the associating guide member have a same width.

8. The electrical connector as claimed in claim 1, further comprising a cap, said cap having two hooks respectively extended from two opposite lateral sides thereof for fastening to the retaining members of said electrically insulative housing.

9. The electrical connector as claimed in claim 1, wherein said electrically insulative housing comprises a body shell installed in a circuit board, a cover shell connectable to said body shell, and a driving device provided between said body shell and said cover shell, said body shell having a plurality of terminal holes for accommodating said conducting terminals, said cover shell having a plurality of through holes corresponding to said conducting terminals.

10. The electrical connector as claimed in claim 9, wherein said driving device is a cam wheel.

11. The electrical connector as claimed in claim 9, wherein said cover shell has a protruding mount for the mounting of said driving device, and a bearing surface for receiving a central processing unit.

12. The electrical connector as claimed in claim 11, wherein said bearing surface has a center protrusion, and a frame extending around the border thereof at an equal height relative to said center protrusion.
